(19) United States
(12) Patent Application Publication
(10) Pub. No.: US 2023/0194688 A1
(43) Pub. Date: Jun. 22, 2023

(54) METHOD FOR DETERMINING A RELATIVE MOUNTING POSITION OF A FIRST SENSOR UNIT IN RELATION TO A SECOND SENSOR UNIT ON AN INDUSTRIAL TRUCK

(71) Applicant: Jungheinrich Aktiengesellschaft, Hamburg (DE)

(72) Inventors: Hannes Bistry, Pinneberg (DE); Benjamin Bruss, Hamburg (DE); Tilmann Renneke, Wedel (DE)

(21) Appl. No.: 18/086,815

(22) Filed: Dec. 22, 2022

(30) Foreign Application Priority Data
Dec. 22, 2021 (DE) 10 2021 134 371.2

(51) Int. Cl. G01S 7/497; G01S 17/894; G01S 17/931

(52) U.S. Cl. CPC G01S 7/497; G01S 17/894; G01S 17/931

(57) ABSTRACT

A method for determining a relative mounting position of a first sensor unit in relation to a second sensor unit on an industrial truck. The method includes placing the industrial truck in a first orientation with respect to a planar structure. The method includes detecting the planar structure using the two sensor units and determining a distance between each respective sensor unit and the planar structure. The method includes placing the industrial truck in a second orientation having at least a different angle between the longitudinal axis of the industrial truck and the planar structure. The method includes detecting the planar structure using the sensor units and determining a distance between each respective sensor unit and the planar structure. The method includes deriving an offset of the sensor units with respect to length and width directions and an angle between the sensor units with respect to a same spatial axis.

### DESCRIPTION

The present invention relates to a method for determining a relative mounting position of a first sensor unit in relation to a second sensor unit on an industrial truck, and to a system for carrying out such a method.

It is known to equip industrial trucks, and in particular driverless transport systems, with a plurality of sensor units, it being possible, for example, for an area around the industrial truck to be monitored for obstacles by two such sensor units. In particular, one of the two sensor units can be provided for personnel protection, and for this purpose can capture a substantially horizontal scanning plane just above the driving surface, while the other of the two sensor units is used to protect the machine, and can be formed, for example, by a 3D area sensor. In this way, such a combination can ensure that both the valid safety requirements with respect to personnel protection are met, and also that obstacles above or below a scanning plane can be detected by typical sensor units, for the purpose of personnel protection - for example, lowered forks from other industrial trucks operating in the same logistics environment.

For a correct evaluation of the obstacle information, it is necessary to know the mounting positions of the sensor units with high precision. A corresponding calibration can be carried out, for example, by measuring the respective mounting positions of the sensor units, and/or elements of the environment can be captured in the sensor data and the positions and orientations of the sensor units can be determined based on knowledge of the position of these elements. For this purpose, however, elements often have to be placed manually in the surroundings of the industrial truck, and measurement processes have to be carried out several times; accordingly, such calibration processes are both complicated to carry out, and are also error-prone as well.

Furthermore, a known practice in the prior art is that of adjusting sensor positions retroactively in parameterisation software. In particular, in known calibration methods, installation parameters of a sensor unit can be entered into such software; six degrees of freedom must be entered - namely, three spatial coordinates and three angle coordinates. The quality of the calibration can then be checked via a display of data captured during operation of the sensor units; for example, an operator can manually check whether corresponding measurement points for a floor area are actually in the floor plane. It is also possible to use reference objects that are expected to be present at a specific position.

Furthermore, it is known to calibrate a 3D area sensor to a floor plane using an available algorithm. A plane is laid through the floor points that belong to the floor using a principal component analysis. In this way, a height of the sensor unit above the ground, an inclination or a pitch angle, and a roll angle can be determined as extrinsic calibration parameters. However, no information can be derived about a rotation angle about a vertical axis - i.e., a yaw angle, nor about the two remaining Cartesian coordinates.

It is also known from the prior art to have a fixed position of such a sensor unit specified via the design thereof, and to set corresponding calibration parameters statically.

Finally, methods are also known in which both available sensor units detect and localise the same object or a group of objects in an area surrounding the industrial truck. Checkerboard patterns or QR codes are often used for this.

In practice, however, it has been found that the calibration processes described and known from the prior art are time-consuming and error-prone. It is also not yet possible in this field to calibrate different sensor systems with respect to one another; and it can be particularly disadvantageous if the reference objects used have to be far away from the vehicle due to the mounting position of the two sensors. This can be the case, for example, in cases where a laser scanner functions as a personnel protection device close to the floor level, while on the other hand a time-of-flight camera is attached to an elevated component as a machine protection device in order to also be able to detect higher obstacles. In this case, the greater distance from the reference objects used automatically leads to increased noise and thus a more pronounced measurement error.

Another disadvantage of the methods described is that often only three of the six calibration parameters mentioned above can be determined, and at least some of the methods can only be used with sensors that can image a floor plane - i.e., not the laser scanners mentioned above, for example, the scanning plane of which usually runs substantially parallel to the driving surface of the industrial truck.

Furthermore, with methods from the prior art, it may be disadvantageous that tolerances in the manufacture of the industrial truck or even tolerances in the manufacture of the sensor units can have a negative impact on the precision of such methods. Furthermore, it is often necessary, because of the method used, to keep the mounting angle of the corresponding sensor units variable.

Finally, in some of the methods known from the prior art, the detection range of the sensor units must match exactly, and a detected or localised object in the environment must be determinable with the current position and rotational orientation of the sensor units. Furthermore, different types of sensors usually cannot be utilised in such processes.

Accordingly, it is the object of the present invention to provide a method for determining a relative mounting position of two sensor units on an industrial truck, which sensor units differ, for example, with respect to their sensor type and cover different areas of use and areas of detection on the industrial truck. Furthermore, an efficient and precise method which is superior to the methods known from the prior art both in terms of efficiency and precision is sought.

For this purpose, the invention proposes a method for determining a relative mounting position of a first sensor unit in relation to a second sensor unit on an industrial truck which has a length direction, a width direction, and a height direction, wherein the first and the second sensor unit have respective detection fields and supply corresponding sensor data. The method includes the steps of placing the industrial truck in a first orientation with respect to a planar structure, detecting the planar structure using the two sensor units, and determining each distance between the corresponding sensor unit and the planar structure in the first orientation, placing the industrial truck in a second orientation with respect to the planar structure, wherein at least the angle between the longitudinal axis of the industrial truck and the planar structure differs between the first orientation and the second orientation, detecting the planar structure using the two sensor units, and determining each distance between the corresponding sensor unit and the planar structure in the second orientation, additionally determining each angle between the corresponding sensor unit and the planar structure in the first orientation and/or second orientation, and deriving the offset of the first and the second sensor unit with respect to the length direction and width direction, and also the angle between the two sensor units with respect to the same spatial axis, in particular the height direction.

It should be expressly pointed out at this point that the planar structure can also include at least two surface portions which are at an angle to one another, in which case the placement of the industrial truck in two orientations with respect to the planar structure is to be understood in such a way that these two orientations are relative to the two separate surface portions. Accordingly, in such an embodiment of the present invention, the two detection steps in the first and the second orientation can be carried out simultaneously, since the two orientations are always present at the same time.

The method according to the invention can thus be used to determine three of the six necessary calibration parameters for mapping a relative mounting position of the two sensor units. And the method according to the invention is suitable for any types of sensor units.

In particular, one of the first or second sensor units can be a laser scanner, and the other sensor unit can be a 3D area scanner, in particular a time-of-flight sensor. Accordingly, such sensor units can be utilised to detect objects such as pallets, obstacles such as people and objects, to localise the industrial truck, to measure a load, or to obtain further information, such as by scanning codes or reading plain text.

According to the invention, in the method described, the sensor data supplied by the sensor units can be transformed and mapped in the same coordinate system, for example a fixed coordinate system of the industrial truck or a coordinate system of one of the two sensor units, such that, in a specific application, for example, obstacle information from a 3D area sensor can be transformed and mapped in the coordinate system of a laser scanner, and processed by the laser scanner, so as to keep the complexity of the safety-relevant driving control process as low as possible.

In order to further increase the precision of the method according to the invention, the steps of placing the industrial truck with respect to the planar structure and detecting the planar structure using the two sensor units, and also of determining each distance and each angle between the sensor unit and the planar structure, can be executed more than twice, such that the corresponding parameters or coordinates are overdetermined.

Generally speaking, the step of deriving the offset of the first and the second sensor unit with respect to the length direction and width direction, and also deriving the angle between the two sensor units with respect to the height direction, can comprise a calculation, in particular an averaging, a geometric reconstruction, or the execution of an optimisation function, wherein, particularly in cases where the placement and the detection as mentioned above are carried out more than twice, the step of the derivation can comprise executing a quadratic optimisation function for evaluating the overdetermined equation system. Furthermore, measurement inaccuracies and possible errors in a calibration of the sensor units in relation to the floor level can be compensated for - for example, by the aforementioned averaging mentioned.

Furthermore, in the first orientation, the second orientation, and/or at least one further orientation, the planar structure can lie at least partially within an overlapping area of the detection fields of the two sensor units. Alternatively, however, the method according to the invention can also be carried out when the detection fields of the two sensor units do not overlap and, for example, the 3D area sensor detects an upper part of the planar structure and the laser scanner scans the lower region of it.

The method according to the invention can also be simplified in that the planar structure is formed substantially vertically, i.e., is designed as a wall, for example. In such a case, the alignment of the planar structure with respect to the height direction is therefore known. However, in other cases of a planar structure not formed vertically, the angle with respect to the vertical can also be determined by means of the 3D area sensor.

As already mentioned above, a simplification of the method according to the invention can also be achieved in that the planar structure comprises at least two surface portions arranged at an angle to one another, so that the placing of the industrial truck in the first orientation in front of the planar structure, and also the placing in the second orientation with respect to the planar structure, and the corresponding detections of the planar structure, can take place in a single step. This is because, due to the two surface portions of the planar structure arranged at an angle to one another, the two orientations relative to the surface portions are automatically adopted.

According to a second aspect, the present invention relates to a system for carrying out such a method, comprising a data processing unit which is operatively coupled to the two sensor units and is configured to carry out the step of the derivation utilizing the sensor data supplied by the sensor units. This system can also include a graphic display or other output means for providing the results of the method and/or means for direct calibration of a system which processes the data from the two sensor units during regular operation of the industrial truck.

When the present invention is considered together with the accompanying drawings, further advantages and features of the invention will become clearer from the following description of an embodiment. In detail, in the drawings:

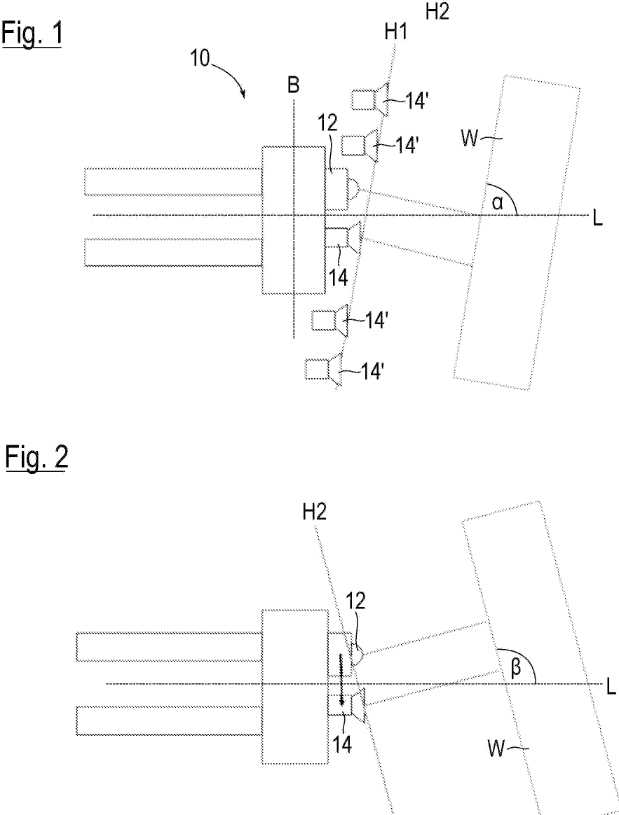

FIGS. 1 and 2 are schematic illustrations of the placement of an industrial truck with respect to a planar structure in a first and a second orientation;

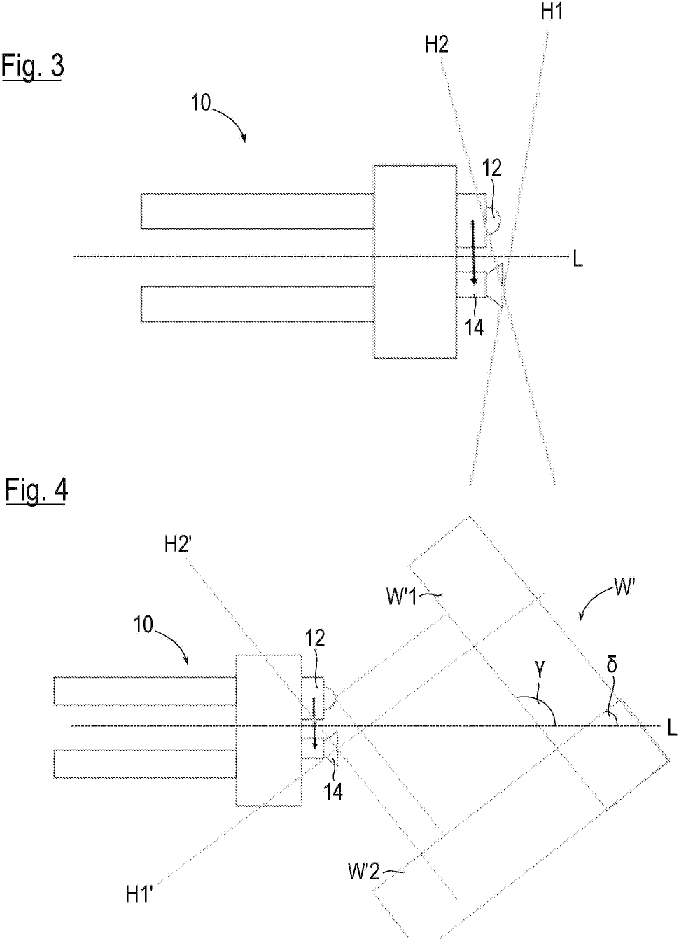

FIG. 3 is a schematic illustration of the derivation of the offset between the first and the second sensor units of the industrial truck of FIGS. 1 and 2;

FIG. 4 is a schematic illustration of the placement of an industrial truck with respect to a planar structure which has two surface portions arranged at an angle to one another; and

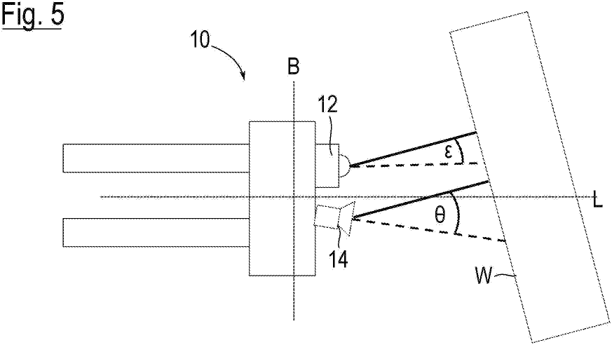

FIG. 5 is a schematic illustration of an example in which there is an angular offset between the two sensor units.

In FIGS. 1 and 2, an industrial truck 10 with a length direction L, a width direction B, and a height direction (not shown) is shown schematically in a plan view, and comprises a laser scanner 12 on the one hand and a time-of-flight camera 14, as a 3D area sensor, on the other hand, as two sensor units. This industrial truck 10 is arranged at a first angle α with respect to a planar structure W in relation to the longitudinal axis L of the industrial truck 10.

In this state, the two sensor units 12 and 14 detect - in regard to the respective distances and respective angles - the planar structure W. An auxiliary line H1 which runs parallel to the two-dimensional structure W and on which, from the point of view of the laser scanner 12, the time-of-flight camera 14 must be located, can be constructed from the data captured by the two sensor units, beginning with the laser scanner 12. To clarify this concept, several positions of the time-of-flight camera that are plausible for the laser scanner are also shown in FIG. 1, and are each denoted by 14′.

Furthermore, a second placement of the industrial truck 10 with respect to the planar structure W is shown in FIG. 2, and the corresponding angle between the planar structure W and the longitudinal axis L of the industrial truck 10 is denoted by the angle β. A corresponding detection of the two-dimensional structure W and evaluation of the data from the two sensor units 12 and 14 results in a second auxiliary line H2 that can be constructed and that again indicates plausible positions of the time-of-flight camera 14 for the laser scanner 12 after a determination of the planar structure W has taken place in polar coordinates.

FIG. 3 indicates how the correct position of the time-of-flight camera 14 in relation to the laser scanner 12 can be determined by constructing an intersection of the two auxiliary lines H1 and H2, so that on the basis of these two captures of the two-dimensional structure W, a corresponding mutual calibration of the two sensor units 12 and 14 to each other with respect to the length direction L, the width direction B, and an angle with respect to the height direction, i.e., a yaw angle, can take place.

Furthermore, FIG. 4 shows in a similar schematic manner an alternative embodiment of the present invention in which a planar structure W′, with two surface portions W1 and W2 arranged at an angle to one another, is used. The two surface portions W1 and W2 are each at a different angle γ and/or δ to the longitudinal axis L of the industrial truck 10, so that the first and second orientation of the industrial truck relative to the planar structure are available at the same time, and the procedure described with regard to FIG. 1 to FIG. 3 can be carried out in a single pass using the corresponding auxiliary lines H1′ and H2′.

Finally, FIG. 5 shows a case in which there is a discrepancy between the angles of the two sensor units in the vehicle 10 of FIG. 1. The intended main axis of the laser scanner 12 substantially points in the direction of the longitudinal axis L of the vehicle, whereas the intended main axis of the time-of-flight camera 14 is rotated by a certain angle to the right, as can be seen from the two dashed lines in FIG. 5.

Accordingly, the two sensor units 12 and 14 also detect the planar structure W at different angles, which are denoted by ε and θ in FIG. 5. If there is an angular discrepancy between the two sensor units 12 and 14 in the manner shown, this can be determined with just a single detection of the planar structure W, by solving for the difference ε - θ, and can be further used to determine the relative mounting position between the two sensor units 12 and 14 and/or can represent a parameter thereof.

1. A method for determining a relative mounting position of a first sensor unit relation to a second sensor unit on an industrial truck, comprising:
placing the industrial truck in a first orientation with respect to a planar structure, wherein the industrial truck has a length direction, a width direction, and a height direction;
detecting the planar structure using the first sensor unit and the second sensor unit and determining, for each of the first sensor unit and the second sensor unit, a distance between the respective sensor unit and the planar structure in the first orientation, wherein the first sensor unit and the second sensor unit each have a respective detection field and supply respective sensor data;
placing the industrial truck in a second orientation with respect to the planar structure, wherein at least an angle between the longitudinal axis of the industrial truck and the planar structure differs between the first orientation and the second orientation;
detecting the planar structure using the the first sensor unit and the second sensor unit and determining, for each of the first sensor unit and the second sensor unit, a respective distance between the respective sensor unit and the planar structure in the second orientation; and
deriving the offset of the first sensor unit and the second sensor unit with respect to the length direction and width direction the angle between the two sensor units the first sensor unit and the second sensor unit with respect to same spatial axis.

2. The method of claim 1, wherein one of the first sensor unit and the second sensor unit units is a laser scanner and the other of the first sensor unit and the second sensor unit is a three-dimensional (3D) area sensor .

3. The method of claim 1 , wherein the sensor data supplied by the sensor units first sensor unit and the second sensor unit is transformed and mapped in same coordinate system.

4. The method of claim 1 , further comprising performing multiple times in at least one further orientation, steps of:
placing the industrial truck in a second orientation with respect to the planar structure, wherein at least an angle between the longitudinal axis of the industrial truck and the planar structure differs between the first orientation and the second orientation; and
detecting the planar structure using the first sensor unit and the second sensor unit and determining, for each of the first sensor unit and the second sensor unit, a respective distance between the respective sensor unit and the planar structure in the second orientation.

5. The method of claim 1, wherein the step of deriving comprises a calculation .

6. The method of claim 4 and 5, wherein the calculation comprises performing a quadratic optimisation function.

7. The method of claim 1 , wherein, in one or more of the first orientation, the second orientation, or at least one further orientation, the planar structure lies at least partially within an overlapping area of the detection fields of the first sensor unit and the second sensor unit.

8. The method of claim 1 according , wherein the planar structure is formed substantially vertically.

9. The method of claim 1 , wherein the planar structure comprises at least two surface portions arranged at an angle to one another.

10. A system, comprising:
a data processing unit which is operatively coupled to a first sensor unit and a second sensor unit wherein the data processing unit is configured to perform operations comprising:
placing the industrial truck in a first orientation with respect to a planar structure, wherein the industrial truck has a length direction, a width direction, and a height direction;
detecting the planar structure using the first sensor unit and the second sensor unit and determining, for each of the first sensor unit and the second sensor unit, a distance between the respective sensor unit and the planar structure in the first orientation, wherein the first sensor unit and the second sensor unit each have a respective detection field and supply respective sensor data;
placing the industrial truck in a second orientation with respect to the planar structure, wherein at least an angle between the longitudinal axis of the industrial truck and the planar structure differs between the first orientation and the second orientation;
detecting the planar structure using the first sensor unit and the second sensor unit and determining, for each of the first sensor unit and the second sensor unit, a respective distance between the respective sensor unit and the planar structure in the second orientation; and
deriving, using the sensor data supplied by the first sensor unit and the second sensor unit, the offset of the first sensor unit and the second sensor unit with respect to the length direction and width direction and the angle between the first sensor unit and the second sensor unit with respect to a same spatial axis.

11. The system of claim 10, wherein one of the first sensor unit and the second sensor unit is a laser scanner and the other of the first sensor unit and the second sensor unit is a three-dimensional (3D) area sensor.

12. The system of claim 10, wherein the sensor data supplied by the first sensor unit and the second sensor unit is transformed and mapped in a same coordinate system.

13. The system of claim 10, wherein the data processing unit is further configured to perform, multiple times in at least one further orientation, operations comprising:
placing the industrial truck in a second orientation with respect to the planar structure, wherein at least an angle between the longitudinal axis of the industrial truck and the planar structure differs between the first orientation and the second orientation; and
detecting the planar structure using the first sensor unit and the second sensor unit and determining, for each of the first sensor unit and the second sensor unit, a respective distance between the respective sensor unit and the planar structure in the second orientation.

14. The system of claim 10, wherein the step of deriving comprises a calculation comprising an averaging, a geometric reconstruction, or the execution of an optimisation function.

15. The system of claim 10, wherein, in one or more of the first orientation, the second orientation, or at least one further orientation, the planar structure lies at least partially within an overlapping area of the detection fields of the first sensor unit and the second sensor unit.

16. The system of claim 10, wherein the planar structure comprises at least two surface portions arranged at an angle to one another.

17. The method of claim 1, further comprising determining a first angle between the first sensor unit and the planar structure and a second angle between the second sensor unit and the planar structure.

18. The method of claim 1, wherein the same spatial axis comprises the height direction.

19. The method of claim 2, wherein the 3D area sensor comprises a time of flight sensor.

20. The method of claim 5, wherein the calculation comprises an averaging, a geometric reconstruction, or an execution of an optimisation function.
